(19) United States
(12) Patent Application Publication
(10) Pub. No.: US 2026/0004528 A1
(43) Pub. Date: Jan. 1, 2026

(54) SKY ENVIRONMENT CONTROL METHOD AND APPARATUS, TERMINAL, AND STORAGE MEDIUM

(71) Applicant: Tencent Technology (Shenzhen) Company Limited, Shenzhen (CN)

(72) Inventors: Xinyang WANG, Shenzhen (CN); Qinjie ZHANG, Shenzhen (CN); Hu WANG, Shenzhen (CN); Qiao LI, Shenzhen (CN); Ning WANG, Shenzhen (CN)

(21) Appl. No.: 19/319,622

(22) Filed: Sep. 4, 2025

Related U.S. Application Data
(63) Continuation of application No. PCT/CN2024/107460, filed on Jul. 25, 2024.

(30) Foreign Application Priority Data
Sep. 25, 2023 (CN) 202311248098.8

(51) Int. Cl. G06T 19/00; A63F 13/60

(52) U.S. Cl. CPC G06T 19/00; A63F 13/60

(57) ABSTRACT

This application discloses a sky environment control method performed by a computer device. The method includes: displaying a sky environment control interface in a UGC editor; obtaining, based on a sky environment change operation in the sky environment control interface, a change signal and a first environment parameter corresponding to the change signal; and changing, in response to the change signal triggered in the virtual scene, a current sky environment in the virtual scene to a sky environment indicated by the first environment parameter.

### CROSS-REFERENCE TO RELATED APPLICATIONS

This application is a continuation application of PCT Patent Application No. PCT/CN2024/107460, entitled “SKY ENVIRONMENT CONTROL METHOD AND APPARATUS, TERMINAL, AND STORAGE MEDIUM” filed on Jul. 25, 2024, which claims priority to Chinese Patent Application No. 202311248098.8, entitled “SKY ENVIRONMENT CONTROL METHOD AND APPARATUS, TERMINAL, AND STORAGE MEDIUM” filed on Sep. 25, 2023, both of which are incorporated herein by reference in their entirety.

### FIELD OF THE TECHNOLOGY

Embodiments of this application relate to the field of computer technologies, and in particular, to a sky environment control method and apparatus, a terminal, and a storage medium.

### BACKGROUND OF THE DISCLOSURE

User generated content (UGC) refers to self-created content shared by users on the Internet. In the game field, designers may encourage users to participate in design of a virtual scene in a game by providing a corresponding UGC editing capability in the game. The virtual scene includes a sky environment, and the sky environment is diversified. For example, the sky environment includes a clear sky during the day or a starry sky during the night.

Usually, each time a user expects to change the sky environment in the virtual scene, the user needs to re-adjust parameters of the sky environment. Therefore, flexibility of a sky environment control method is poor.

### SUMMARY

Embodiments of this application provide a sky environment control method and apparatus, a terminal, and a storage medium. Technical solutions are as follows:

According to an aspect, a sky environment control method is performed by a computer device, and the method includes:
displaying a sky environment control interface in a UGC editor;
obtaining, based on a sky environment change operation in the sky environment control interface, a change signal and a first environment parameter corresponding to the change signal; and
changing, in response to the change signal triggered in the virtual scene, a current sky environment in the virtual scene to a sky environment indicated by the first environment parameter.

According to another aspect, a computer device includes a processor and a memory, the memory having at least one computer program stored therein, and the at least one computer program, when being loaded and executed by the processor, causing the computer device to implement operations performed in the sky environment control method according to the foregoing aspects.

According to another aspect, a non-transitory computer-readable storage medium is provided. The computer-readable storage medium has at least one computer program stored therein. The at least one computer program, when loaded and executed by a processor of a computer device, causes the computer device to implement the operations performed in the sky environment control method in the foregoing aspects.

According to the solution provided in embodiments of this application, a UGC editor integrates a function of controlling a sky environment in a virtual scene in a sky environment control interface, so that a user can configure a change signal and an environment parameter in the sky environment control interface. When the change signal is triggered in the virtual scene, the sky environment in the virtual scene is automatically changed to a sky environment indicated by the environment parameter. That is, the user can freely configure an occasion for changing the sky environment and a sky environment to which the sky environment is changed, to automatically change the sky environment when the change occasion is satisfied, thereby improving operability of the user for the sky environment, and further improving flexibility in controlling the sky environment. In addition, the user can configure the change signal and the environment parameter by performing an operation in the sky environment control interface, without the need to arrange related components in the virtual scene, thereby improving convenience for controlling the sky environment.

### BRIEF DESCRIPTION OF THE DRAWINGS

FIG. 1 is a schematic diagram of an implementation environment according to an embodiment of this application.

FIG. 2 is a flowchart of a sky environment control method according to an embodiment of this application.

FIG. 3 is a flowchart of a sky environment control method according to an embodiment of this application.

FIG. 4 is a schematic diagram of a change event editing sub-interface according to an embodiment of this application.

FIG. 5 is a schematic diagram of another change event editing sub-interface according to an embodiment of this application.

FIG. 6 is a schematic diagram of another change event editing sub-interface according to an embodiment of this application.

FIG. 7 is a schematic diagram of another change event editing sub-interface according to an embodiment of this application.

FIG. 8 is a schematic diagram of another change event editing sub-interface according to an embodiment of this application.

FIG. 9 is a schematic diagram of another change event editing sub-interface according to an embodiment of this application.

FIG. 10 is a schematic diagram of a virtual scene according to an embodiment of this application.

FIG. 11 is a schematic diagram of another change event editing sub-interface according to an embodiment of this application.

FIG. 12 is a schematic diagram of another change event editing sub-interface according to an embodiment of this application.

FIG. 13 is a schematic diagram of another virtual scene according to an embodiment of this application.

FIG. 14 is a flowchart of still another sky environment control method according to an embodiment of this application.

FIG. 15 is a schematic diagram of processing logic of an animation driving timer according to an embodiment of this application.

FIG. 16 is a flowchart of yet another sky environment control method according to an embodiment of this application.

FIG. 17 is a flowchart of yet another sky environment control method according to an embodiment of this application.

FIG. 18 is a flowchart of a signal control method in a virtual scene according to an embodiment of this application.

FIG. 19 is a flowchart of a change event control method according to an embodiment of this application.

FIG. 20 is a schematic diagram of another sky environment control interface according to an embodiment of this application.

FIG. 21 is a flowchart of yet another sky environment control method according to an embodiment of this application.

FIG. 22 is a schematic diagram of a sky environment editing sub-interface according to an embodiment of this application.

FIG. 23 is a schematic diagram of another sky environment editing sub-interface according to an embodiment of this application.

FIG. 24 is a diagram of a system architecture of a sky environment control method according to an embodiment of this application.

FIG. 25 is a flowchart of yet another sky environment control method according to an embodiment of this application.

FIG. 26 is a schematic structural diagram of a sky environment control apparatus according to an embodiment of this application.

FIG. 27 is a schematic structural diagram of another sky environment control apparatus according to an embodiment of this application.

FIG. 28 is a schematic structural diagram of a terminal according to an embodiment of this application.

### DESCRIPTION OF EMBODIMENTS

To make objectives, technical solutions, and advantages of embodiments of this application clearer, the following further describes in detail implementations of this application with reference to the accompanying drawings.

The terms “first”, “second”, and the like used in this application may be used for describing various concepts in this specification. However, the concepts are not limited by the terms unless otherwise specified. The terms are merely used for distinguishing one concept from another concept. For example, without departing from the scope of this application, a first environment parameter may be referred to as a second environment parameter, and similarly, the second environment parameter may be referred to as the first environment parameter.

Information (including but not limited to user equipment information, user personal information, and the like), data (including but not limited to data for analysis, stored data, displayed data, and the like), and signal (including but not limited to a signal transmitted between a user terminal and another device) involved in this application are all fully authorized by users or by relevant parties, and collection, use, and processing of relevant data need to comply with relevant laws, regulations, and standards of relevant countries and regions.

First, relevant terms involved in this application are introduced:

User generated content (UGC): The UGC refers to self-created content shared by users on the Internet. In the game field, designers may encourage users to participate in design of game content such as a level map, a gameplay, and an ecology by providing a corresponding UGC editing capability in a game. The game content is designed by the user, so that a sense of belonging of the user and richness of the game content are improved, and personalized requirements are further satisfied.

Virtual scene: The virtual scene is a virtual scene displayed (or provided) by a client when running on a terminal. The virtual scene may be a simulated scene of the real world, or may be a semi-simulated and semi-fictional scene, or may be a purely fictional scene. The virtual scene may be any one of a two-dimensional virtual scene, a 2.5-dimensional virtual scene, or a three-dimensional virtual scene. This is not limited in this application. Descriptions are made by using an example in which the virtual scene is a three-dimensional virtual scene in the following embodiments.

Weather environment: The weather environment is formed by a sky background, sky illumination, and other elements configured for simulating a sky status in the real world, to present the real sky status in the virtual scene. For example, a cloudy sky, a sunny sky, a sunset sky, a rainy sky, a night sky, or the like is presented in a virtual environment. This is not limited in the embodiments.

The sky background may be implemented by using a sky ball or a sky box, and is rendered on a background model by using a background map as a background of the virtual scene. The sky illumination is a general term for light sources in the sky in the virtual scene, and includes a directional light source and sky light. The directional light source refers to a light source having a specific illumination direction. The sky light refers to sky illumination (Sky Light). The sky light captures a distant part in the virtual scene as a light source to be applied in the virtual scene. The sky illumination may be static sky illumination, fixed sky illumination, movable sky illumination, or the like.

In embodiments of this application, the sky environment in the virtual scene supports user customization, including customization of the sky background and customization of the sky illumination.

Change signal: The change signal in embodiments of this application is a signal configured for triggering switching of the sky environment. In some embodiments, the change signal is triggered in a particular condition. The particular condition may include: a particular manual trigger operation is received, particular voice is received, a particular event exists in the virtual scene, or the like.

In embodiments of this application, the change signal may be user-defined, and the change signal and an environment parameter of the sky environment form a sky environment switching event. Based on the created sky environment switching event, when the change signal is triggered, sky environment switching can be performed based on the environment parameter corresponding to the change signal.

FIG. 1 is a schematic diagram of an implementation environment according to an embodiment of this application. As shown in FIG. 1, the implementation environment includes a terminal 101 and a server 102. The terminal 101 and the server 102 are directly or indirectly connected in a wired or wireless communication manner. FIG. 1 only shows an example in which the server 102 is connected to the terminal 101. In addition, the server 102 may be connected to another terminal.

In some embodiments, the terminal 101 is a smartphone, a tablet computer, a notebook computer, a desktop computer, a smart speaker, a smart television, a smart watch, a laptop portable computer, an e-book reader, a video game console, a hand-held portable game device, or the like, but is not limited thereto. The server 102 is an independent physical server, or the server 102 is a server cluster or a distributed system including a plurality of physical servers.

In some embodiments, the terminal 101 includes a memory and a processor. The memory may include one or more computer-readable storage media, and an operating system and a game application are installed in the memory. The game application may be any one of a level-based game, a casual battle game, a massive multi-player online game (MMOG), a board game, a multi-player online battle arena (MOBA), a simulation game (SLG), a virtual reality application program, a three-dimensional map program, a first-person shooting (FPS) game, and a multi-player gunfight survival game. The operating system is basic software provided for the game application to perform secure access to computer hardware. The operating system supports downloading, installation, and running of the game application.

In some embodiments, the server 102 is a game server, the terminal 101 runs a game application provided by the server 102, and the terminal 101 interacts with the server 102 through the game application. The server 102 provides a virtual scene for the terminal 101. The terminal 101 can display a virtual scene interface and the like by using the virtual scene provided by the server 102, and the terminal 101 can control the virtual scene based on the virtual scene interface. The server 102 is configured to perform background processing based on control of the virtual scene by the terminal 101, and provide background support for the terminal 101. It is clear that the virtual scene may alternatively be provided by the game application in the terminal 101, in other words, the terminal 101 can display the virtual scene interface without the help of the server 102 (for example, in a single-player mode).

The game application includes a UGC editor. The UGC editor provides a function of performing customized creation on a virtual scene, and supports a user to perform operations such as editing, saving, and publishing on the virtual scene. When editing a virtual scene, a user may set up different virtual scenes by using virtual items, and may change an environment in the virtual scene, for example, a weather environment, a sky environment, or a landscape environment. The user performs the operations by using the terminal 101, and stores a virtual scene that is being edited or has been edited into the terminal 101. In some embodiments, the terminal 101 uploads virtual scene information saved by the user to the server 102. Alternatively, the terminal 101 provides the virtual scene information for the game application.

In some embodiments, the terminal 101 may locally edit a sky environment change event, and only locally apply the sky environment change event. Alternatively, the terminal 101 may upload an edited sky environment change event to the server 102, and the server 102 distributes the sky environment change event to another terminal, for the another terminal to use. The another terminal may be a terminal that has a social relationship with the current terminal, a terminal specified by the current terminal, or a terminal in a same battle. This is not limited in the embodiments.

The sky environment control method provided in embodiments of this application may be applied to any scenario of controlling the sky environment in the virtual scene.

For example, a UGC editor is provided in a video game application. A user may create a virtual scene in a customized manner by using the UGC editor. The virtual scene is configured for simulating a real environment in reality. The user may control a virtual object to perform activities in the virtual scene. The virtual scene includes a sky environment. To enhance realness of the virtual scene, the sky environment in the virtual scene may be different under different conditions. For example, when the weather is clear, the sky environment in the virtual scene is a cloudless clear sky; when the weather is nighttime, the sky environment in the virtual scene is a twinkling starry sky; and when the weather is rainy, the sky environment in the virtual scene is a gloomy sky. Therefore, according to the method provided in embodiments of this application, the user can freely set, in the UGC editor, a change signal that triggers change of the sky environment and a sky environment after the change, to flexibly control the sky environment in the virtual scene.

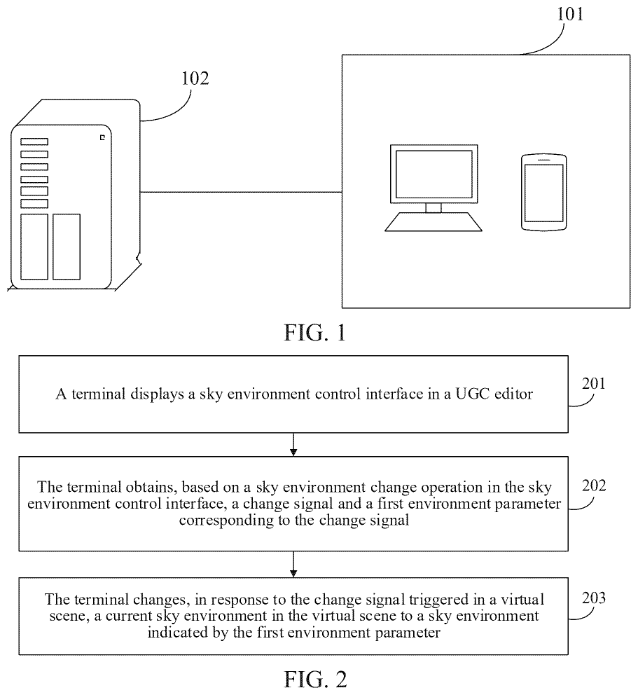

FIG. 2 is a flowchart of a sky environment control method according to an embodiment of this application. This embodiment of this application is performed by a terminal. The method includes the following operations:

201: The terminal displays a sky environment control interface in a UGC editor.

In some embodiments, a game application runs in the terminal, the game application has a UGC editor, and the UGC editor is at least configured to control a sky environment in a virtual scene. The UGC editor is an editor configured to edit self-created content of a user, and supports the user in creating a virtual item to enrich the virtual scene. The virtual item in the virtual scene is created by the user by using the UGC editor, to establish the virtual scene including rich virtual items.

The virtual scene is configured for simulating a real environment in reality. The virtual scene includes a sky environment, and the sky environment includes a series of elements related to simulating the real environment, such as a sky background and sky illumination. In the virtual scene, the sky background may be referred to as a sky ball or a sky box. The sky background is rendered on a background model by using a background map as a background of the virtual scene. The sky illumination is a general term for light sources in the sky in the virtual scene, and includes a directional light source and sky light. The directional light source refers to a light source having a specific illumination direction. The sky light refers to sky illumination (Sky Light). The sky light captures a distant part in the virtual scene as a light source to be applied in the virtual scene. The sky illumination may be static sky illumination, fixed sky illumination, movable sky illumination, or the like.

A function of controlling the sky environment by the UGC editor is mainly described in embodiments of this application. The UGC editor provides the sky environment control interface. The sky environment control interface is configured to control the sky environment in the virtual scene, for example, control the sky background or illumination in the sky environment.

202: The terminal obtains, based on a sky environment change operation in the sky environment control interface, a change signal and a first environment parameter corresponding to the change signal.

The sky environment control interface provides a function of controlling the sky environment to change. If the user expects to customize a sky environment change event in the virtual scene, a sky environment change operation is performed in the sky environment control interface, and the terminal may obtain, based on the sky environment change operation, a change signal set by the user and a first environment parameter corresponding to the change signal. In other words, the sky environment change operation is configured for setting a sky environment change event including a change signal and an environment parameter.

The change signal is a signal configured for triggering the sky environment to change, and the change signal may be triggered based on a particular trigger condition. In some embodiments, the trigger condition may include a manual operation trigger condition (for example, a player triggers the change signal by using a particular manual operation), a voice trigger condition (for example, a player triggers the change signal by using particular voice), an event trigger condition (for example, a particular event in the virtual scene triggers the change signal), and the like. This is not limited in the embodiments.

The change signal is a signal customized by the user or a signal selected by the user from preset signals provided by the UGC editor, and the change signal may be formed by a text, a number, a letter, or a symbol.

In some embodiments, the first environment parameter includes a parameter corresponding to at least one element affecting a sky status in the virtual scene. For example, the first environment parameter includes a sky background parameter and an illumination parameter. The sky background parameter is configured for indicating the sky background in the sky environment, and the illumination parameter is configured for indicating the sky illumination in the sky environment.

In some embodiments, the first environment parameter may be a target environment parameter or a relative environment parameter. The target environment parameter is configured for indicating an environment parameter of a sky environment after switching, and the relative environment parameter is configured for indicating an environment parameter difference of the sky environment after switching relative to the sky environment before switching.

For example, when the first environment parameter is the target environment parameter, the first environment parameter includes a weather background A and an illumination parameter B. Alternatively, when the first environment parameter is the relative environment parameter, the first environment parameter includes an illumination difference C.

It may be understood as that the change signal and the first environment parameter form the sky environment change event, and the sky environment change event refers to changing the sky environment in the virtual scene to a sky environment indicated by the first environment parameter when the change signal is triggered. In other words, the change signal and the first environment parameter are set in the sky environment control interface, so that a sky environment change event that can be automatically triggered is deployed in the virtual scene.

203: The terminal changes, in response to the change signal triggered in the virtual scene, a current sky environment in the virtual scene to a sky environment indicated by the first environment parameter.

In some embodiments, when the sky environment change event is applied, each time the terminal detects in the virtual scene that the change signal is triggered, the terminal changes the current sky environment in the virtual scene to the sky environment indicated by the first environment parameter, to implement a presentation effect of automatically changing the sky environment in the virtual scene.

In some embodiments, when the first environment parameter is the target environment parameter, the terminal displays the sky environment based on the target environment parameter.

In some embodiments, when the first environment parameter is the relative environment parameter, in other words, represents a difference between the target environment parameter and the current environment parameter, the terminal determines the target environment parameter based on the environment parameter of the current sky environment and the first environment parameter, to display the sky environment based on the target environment parameter.

In a possible scenario, the user may set and apply the sky environment change event in the sky environment control interface in advance. In a battle process, when recognizing the change signal, the terminal changes the sky environment of the virtual scene in the battle.

In some embodiments, the first environment parameter is applied by only the current terminal, or the first environment parameter is applied by all or some terminals that participate in the battle. For example, the first environment parameter may be applied to all terminals in the battle, or applied to only terminals that belong to the same side as the current terminal in the battle (for example, when the player side wins the battle, sky environments of all terminals on the player side are changed to be sunny), or applied only to terminals that belong to different camps from the current terminal in the battle (for example, when the player side wins the battle, sky environments of all terminals on the enemy side are changed to be covered by clouds).

According to the method provided in embodiments of this application, a UGC editor integrates a function of controlling a sky environment in a virtual scene in a sky environment control interface, so that a user can configure a change signal and an environment parameter in the sky environment control interface. When the change signal is triggered in the virtual scene, the sky environment in the virtual scene is automatically changed to a sky environment indicated by the environment parameter. That is, the user can freely configure an occasion for changing the sky environment and a sky environment to which the sky environment is changed, to automatically change the sky environment when the change occasion is satisfied, thereby improving operability of the user for the sky environment, and further improving flexibility in controlling the sky environment. In addition, the user can configure the change signal and the environment parameter by performing an operation in the sky environment control interface, without the need to arrange related components in the virtual scene, thereby improving convenience for controlling the sky environment.

The foregoing FIG. 2 is merely a brief description of the sky environment control method, and for a more detailed process of the sky environment control method, refer to the following embodiments.

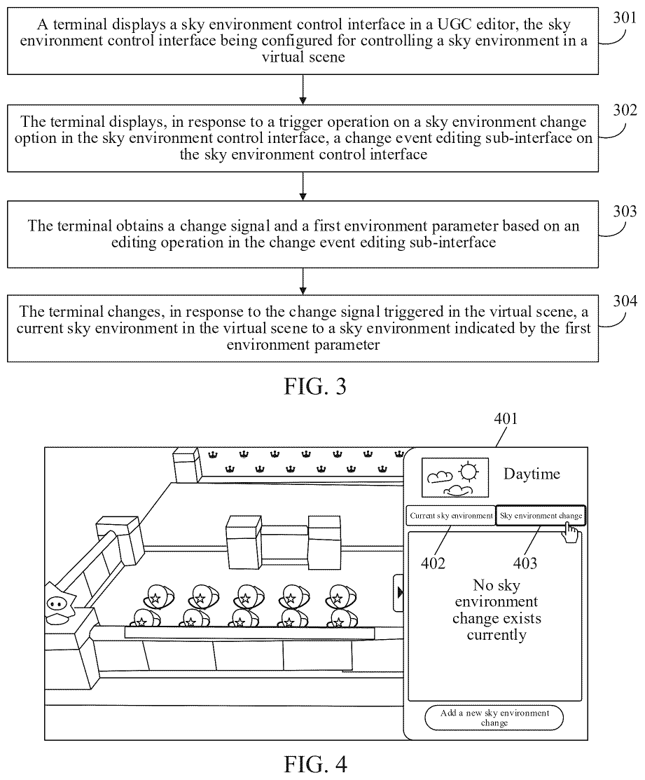

FIG. 3 is a flowchart of another sky environment control method according to an embodiment of this application. This embodiment of this application is performed by a terminal. Referring to FIG. 3, the method includes the following operations:

301: The terminal displays a sky environment control interface in a UGC editor, the sky environment control interface being configured for controlling a sky environment in a virtual scene.

In a possible implementation, the terminal displays a virtual scene interface. The virtual scene interface is configured for displaying the virtual scene. For example, when the virtual scene includes a virtual object operated and controlled by a user, the virtual scene interface is configured for displaying a virtual scene within a viewing angle range of the virtual object. The virtual scene interface further includes a plurality of function options, and the plurality of function options include a sky environment option. The terminal displays the sky environment control interface in response to a trigger operation on the sky environment option.

In some embodiments, the terminal displays the sky environment control interface at an upper layer of the virtual scene interface, a size of the sky environment control interface is smaller than a size of the virtual scene interface, and the sky environment control interface blocks a partial area in the virtual scene interface.

302: The terminal displays, in response to a trigger operation on a sky environment change option in the sky environment control interface, a change event editing sub-interface on the sky environment control interface.

The sky environment control interface includes the sky environment change option and a sky environment editing option. The sky environment change option is configured for triggering displaying the change event editing sub-interface. The change event editing sub-interface is configured for creating a sky environment change event, that is, setting a change signal and an environment parameter in the sky environment change event. The sky environment editing option is configured for triggering displaying a sky environment editing sub-interface, and the sky environment editing sub-interface is configured for editing a current sky environment in the virtual scene, that is, setting an environment parameter of the current sky environment. In this embodiment, only the change event editing sub-interface is described in detail, and for detailed descriptions of the sky environment editing sub-interface, refer to the following embodiment shown in FIG. 21.

If the user expects to create the sky environment change event, the trigger operation on the sky environment change option in the sky environment control interface is performed, and the terminal displays the change event editing sub-interface in the sky environment control interface in response to the trigger operation on the sky environment change option.

FIG. 4 is a schematic diagram of a sky environment control interface according to an embodiment of this application. As shown in FIG. 4, a sky environment control interface 401 is displayed on the right side of a virtual scene interface, and the sky environment control interface 401 includes a sky environment editing option 402 and a sky environment change option 403. When the user triggers the sky environment change option 403, the change event editing sub-interface is displayed in the sky environment control interface 401. When there is no created sky environment change event, that is, when a change signal and a corresponding environment parameter are not set yet, a prompt text “No sky environment change temporarily” is displayed on the change event editing sub-interface.

303: The terminal obtains a change signal and a first environment parameter based on an editing operation in the change event editing sub-interface.

The user performs an editing operation on the change event editing sub-interface, to set the change signal and the first environment parameter, and the terminal may obtain, based on the editing operation, the first environment parameter of the change signal set by the user.

In some embodiments, the change event editing sub-interface includes a change signal editing area and an environment parameter editing area. The change signal editing area includes a control configured for editing the change signal, and the environment parameter editing area includes a control configured for editing the environment parameter. Correspondingly, the terminal determines the change signal based on an editing operation on the control in the change signal editing area, and determines the first environment parameter based on an editing operation on the control in the environment parameter editing area.

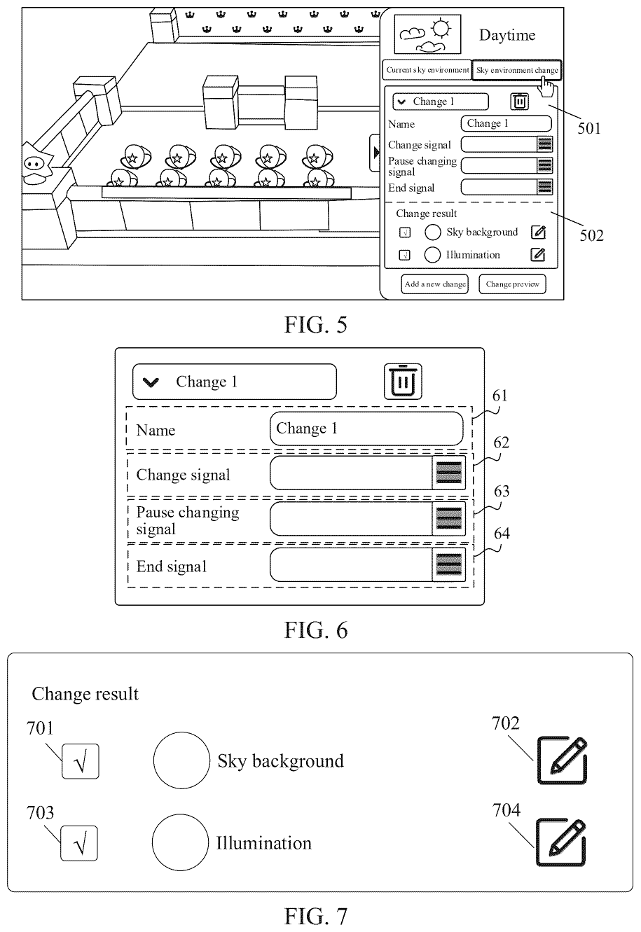

In a possible implementation, the change event editing sub-interface includes a creation option of the sky environment change event. As shown in FIG. 4, the creation option is an option of “Add a new sky environment change”. The terminal displays the change signal editing area and the environment parameter editing area in response to a trigger operation on the creation option. As shown in FIG. 5, a change event editing sub-interface includes a change signal editing area 501 and an environment parameter editing area 502. A user may edit a change signal in the signal editing area 501, and edit a first environment parameter in the environment parameter editing area 502. In this case, the change event editing sub-interface further includes a creation option and a preview option. The creation option is a “Add a new change” option, and the preview option is a “Change preview” option. When the user triggers the preview option, the terminal displays an effect of changing the current sky environment in the virtual scene to a sky environment indicated by a currently edited environment parameter.

In a possible implementation, a process in which the terminal obtains the change signal and the first environment parameter based on the editing operation on the change event editing sub-interface includes the following operation 3031 to operation 3033.

3031: The terminal obtains the change signal based on a signal editing operation in the change event editing sub-interface.

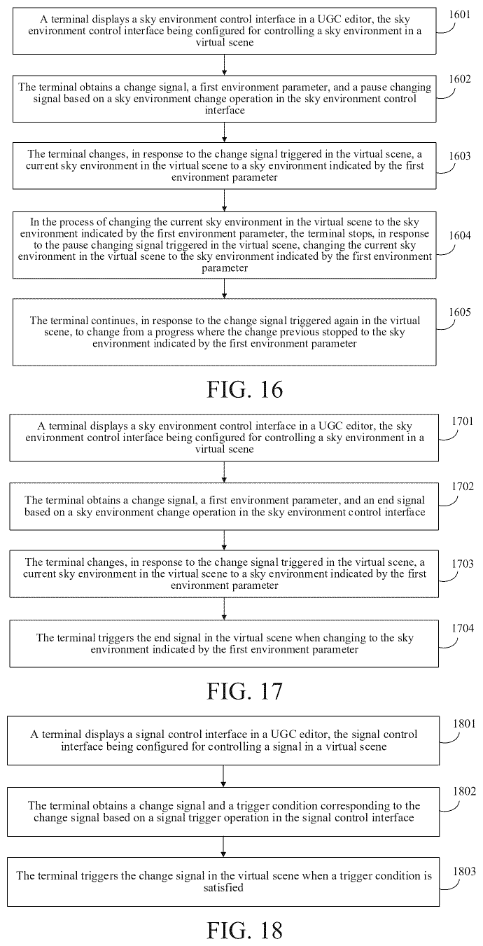

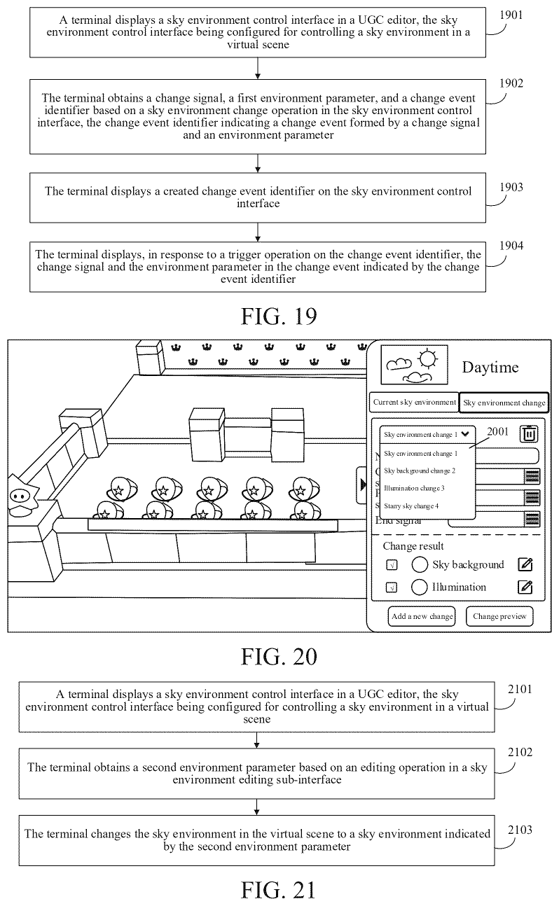

The user performs a signal editing operation in the change event editing sub-interface, to set the change signal, and the terminal may obtain, based on the signal editing operation, the change signal set by the user. As shown in FIG. 6, a signal editing area is displayed in the change event editing sub-interface. The signal editing area includes a “name” editing box 61, a “change signal” editing box 62, a “pause changing signal” editing box 63, and an “end signal” editing box 64. The “name” editing box 61 is configured for editing a change event identifier, and for details of the change event identifier, refer to the following embodiment of FIG. 19. The “change signal” editing box 62 is configured for editing a change signal. The “pause changing signal” editing box 63 is configured for editing a pause changing signal, and for details of the pause changing signal, refer to the following embodiment of FIG. 16. The “end signal” editing box 64 is configured for editing an end signal, and for details of the end signal, refer to the following embodiment of FIG. 17.

In some embodiments, the change signal may be selected from candidate change signals, or the change signal may be customized by the user.

In some embodiments, to avoid change conflicts, in a signal editing process, the terminal detects whether a currently edited change signal is consistent with a change signal in a created sky environment change event. If the currently edited change signal is consistent with the change signal in the created sky environment change event, the terminal prompts to re-edit the change signal.

It is clear that in another possible implementation, when different sky environment change events are allowed to have a same change signal, the terminal may prompt to set priorities for different environment parameters corresponding to the same change signal. Subsequently, the terminal sequentially applies the environment parameter according to the priorities.

3032: The terminal obtains a first sky background parameter based on a sky background editing operation in the change event editing sub-interface.

The sky environment includes a sky background, and therefore, the environment parameter of the sky environment includes a sky background parameter. The user executes the sky background editing operation in the change event editing sub-interface, to set the first sky background parameter. The terminal may obtain, based on the sky background editing operation, the first sky background parameter set by the user.

As shown in FIG. 7, an environment parameter editing area is displayed in the change event editing sub-interface. The environment parameter editing area includes a selection box 701 and an editing option 702 of the sky background. If the user expects to change the sky background during sky environment change, the selection box 701 of the sky background is checked, to perform a trigger operation on the editing option 702 of the sky background. The terminal displays a sky background editing sub-interface in response to the trigger operation on the editing option 702, and the user performs the sky background editing operation in the sky background editing sub-interface.

In some embodiments, the sky background editing operation is configured for editing at least one of a sky background image and a sky rotation angle. Correspondingly, the sky background parameter obtained by the terminal includes at least one of the sky background image and the sky rotation angle.

The sky background image is an image for mapping on a sky background model in the virtual scene. The sky rotation angle is an angle at which the sky background image is mapped on the sky background model, or may be understood as an angle of a sky box or a sky ball. Patterns on the sky background image are located at different positions of the sky background model in the virtual scene at different sky rotation angles, to present different sky environments.

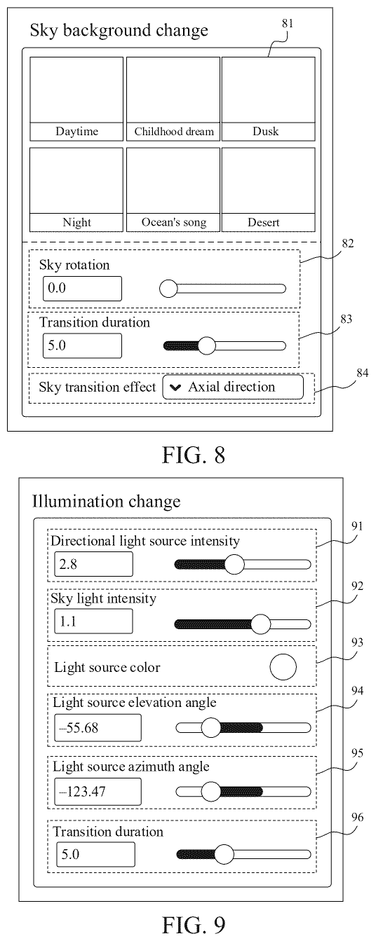

As shown in FIG. 8, a to-be-selected sky background image 81 and a sky rotation angle editing box 82 are displayed on the sky background editing sub-interface. A transition duration editing box 83 and a sky transition effect setting box 84 are further displayed on the sky background editing sub-interface. The transition duration refers to duration in which the sky background in the virtual scene is changed to a sky background indicated by the sky background parameter. For the transition duration and the sky transition effect, refer to the following embodiment of FIG. 14.

3033: The terminal obtains a first illumination parameter based on an illumination editing operation in the change event editing sub-interface.

The sky environment includes illumination, and the environment parameter of the sky environment includes an illumination parameter. The user performs an illumination editing operation in the change event editing sub-interface, to set the first illumination parameter. The terminal may obtain, based on the illumination editing operation, the first illumination parameter set by the user.

In some embodiments, as shown in FIG. 7, an environment parameter editing area is displayed in the change event editing sub-interface. The environment parameter editing area includes a selection box 703 and an editing option 704 of the illumination. If the user expects to change the illumination during sky environment change, the selection box 703 of the illumination is checked, to perform a trigger operation on the editing option 704 of the illumination. The terminal displays an illumination editing sub-interface in response to the trigger operation on the editing option 704, and the user performs the illumination editing operation in the illumination editing sub-interface.

In some embodiments, the illumination is a general term for light sources in the sky in the virtual scene, and includes at least one of a directional light source and sky light. Correspondingly, the illumination parameter includes at least one of a directional light source intensity, a sky light intensity, a light source color of the directional light source, a light source elevation angle of the directional light source, and a light source azimuth angle of the directional light source.

As shown in FIG. 9, an editing box 91 of the directional light source, an editing box 92 of the sky light intensity, an editing option 93 of the light source color, an editing box 94 of the light source elevation angle, and an editing box 95 of the light source azimuth angle are displayed in the illumination editing sub-interface. An editing box 96 of the transition duration is further displayed in the illumination editing sub-interface. The transition duration refers to duration in which the illumination in the virtual scene is changed to illumination indicated by the illumination parameter. For the transition duration, refer to the following embodiment of FIG. 14.

In embodiments of this application, the first environment parameter includes at least one of the first sky background parameter and the first illumination parameter. The terminal performs operation 3031, to obtain the change signal. The terminal performs at least one of operation 3032 or operation 3033, to obtain at least one of the first sky background parameter or the first illumination parameter, to form the first environment parameter.

In embodiments of this application, elements in the sky environment are divided into the sky background and the illumination. The user may select, through a check operation, to perform customized change on at least one of the sky background or the illumination, to satisfy effect requirements for different sky environments in various virtual scenes. The user may freely match different sky background effects and illumination effects, thereby further improving flexibility in controlling the sky environment.

In addition, in embodiments of this application, the sky light element is further added to the illumination of the sky environment, to help enhance an adjustable effect in the sky environment, thereby further improving reality of the sky environment.

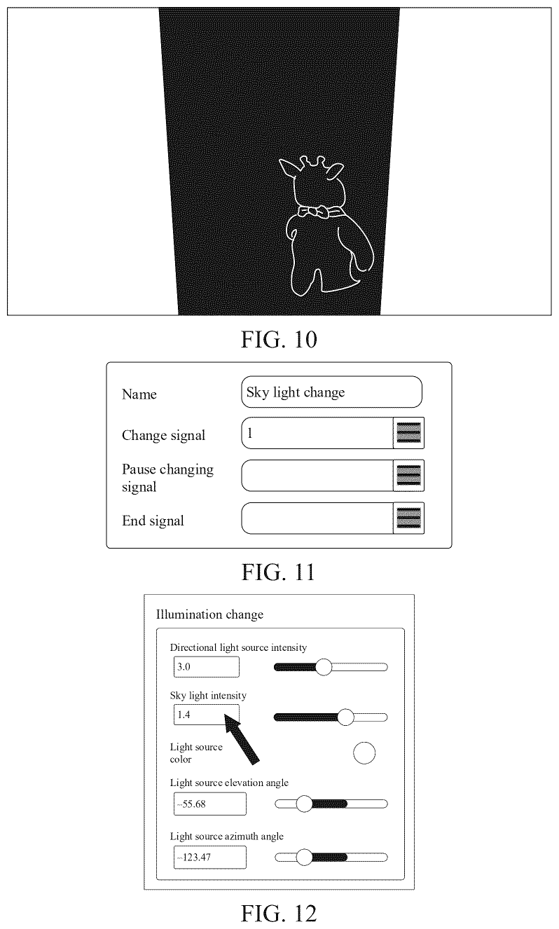

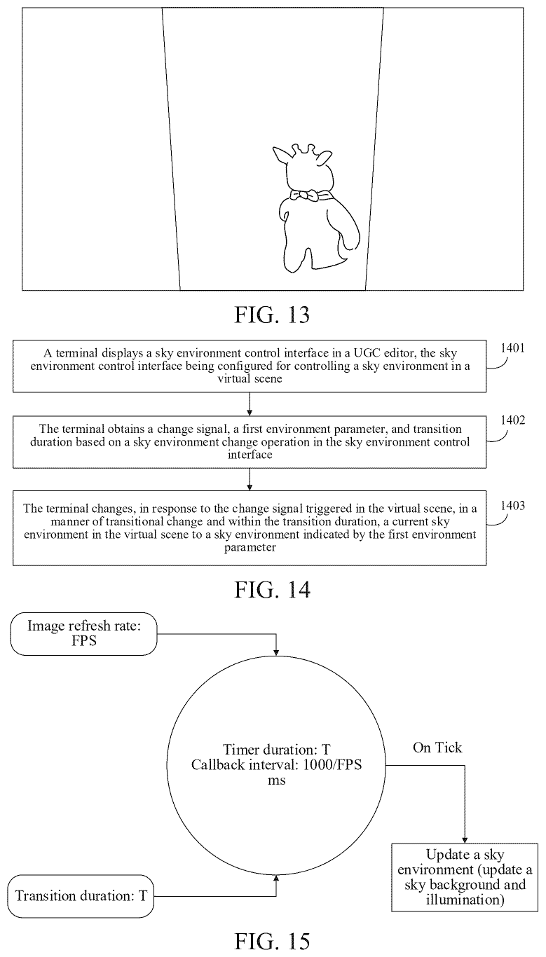

FIG. 10 is a schematic diagram of a virtual scene according to an embodiment of this application. As shown in FIG. 10, when the sky light intensity is low, a virtual object enters an indoor room in the virtual scene, and indoor brightness is low, and therefore, the virtual object is in the dark. Based on this, the user may create a change event for changing the sky light. As shown in FIG. 11, the user may create a change event named “sky light change”, and set a change signal to “1”. As shown in FIG. 12, the sky light intensity is set to a large value: 1.4, and when the change signal “1” is triggered in the virtual scene, the sky light in the virtual scene is changed into sky light with a sky light intensity of 1.4. As shown in FIG. 13, after the sky light intensity is increased, when the sky light intensity is high, in comparison with FIG. 10, an indoor room in which the virtual object is located is brighter.

In addition, a set of environment parameters configured in the sky environment control interface may include a sky background parameter and an illumination parameter. The sky background parameter and the illumination parameter are controlled by a same set of logic. The user may configure the sky background parameter and the illumination parameter in the sky environment control interface at the same time, to change the sky background and the illumination at the same time in one sky environment change event instead of dividing the sky background and the illumination into two sets of completely independent logic for processing, thereby further improving convenience of changing the sky environment, and facilitating improving efficiency of changing the sky environment.

304: The terminal changes, in response to the change signal triggered in the virtual scene, a current sky environment in the virtual scene to a sky environment indicated by the first environment parameter.

In some embodiments, when the first environment parameter includes the first sky background parameter and the first illumination parameter, the terminal simultaneously changes the sky background to a sky background indicated by the first sky background parameter and changes the illumination to illumination indicated by the first illumination parameter. When the first environment parameter includes only the first sky background parameter, the terminal only needs to change the sky background to a sky background indicated by the first sky background parameter, and does not need to change the current illumination. When the first environment parameter includes only the first illumination parameter, the terminal only needs to change the illumination to illumination indicated by the first illumination parameter, and does not need to change the current sky background.

In a possible implementation, any change signal and a corresponding environment parameter are stored in a form of a sky environment change event. For example, each sky environment change event corresponds to a change event identifier, and the change event identifier, the change signal, and the environment parameter are stored in correspondence.

In response to any signal triggered in the virtual scene, the terminal matches the signal with a signal corresponding to each change event identifier, and if determining that the signal is a change signal corresponding to a change event identifier, the terminal changes the sky environment in the virtual scene to an environment parameter corresponding to the change event identifier.

In some embodiments, if determining that the signal is a change signal corresponding to a plurality of change event identifiers, the terminal sequentially adds the determined plurality of change event identifiers to a waiting queue, and then sequentially changes, starting from a first change event identifier in the waiting queue, the sky environment in the virtual scene to a sky environment indicated by the environment parameter corresponding to the change event identifier in the waiting queue.

The terminal may add the plurality of change event identifiers to the waiting queue according to a creation sequence of sky environment change events (for example, according to a sequence of creation events in a chronological order), or may add the plurality of change event identifiers to the waiting queue according to priorities set for the sky environment change events (for example, according to a sequence of priorities in descending order). This is not limited in the embodiments.

According to the method provided in embodiments of this application, editing logic of change information and editing logic of a plurality of parameters related to the sky environment change are integrated into a sky environment managing interface provided by the UGC editor, and a user may customize a change signal and various environment parameters based on a requirement of the user, to dynamically change the sky environment in the virtual scene. In addition, the user can freely select elements that need to be changed in one sky environment change, for example, the sky background and the illumination, so that a freedom degree for changing the sky environment by the user is increased, and a function of independently or collaboratively changing different elements is also satisfied, thereby increasing the flexibility of changing the sky environment by the user.

In a possible implementation, the sky environment change may be completed within duration of a single frame, in other words, the current sky environment is switched to a target sky environment within the duration of the single frame. In another possible implementation, to avoid sudden change of the sky environment, the terminal may complete the sky environment change in a plurality of frames, to improve smoothness of the change process. Correspondingly, when the sky environment change event is set, the transition duration needs to be additionally set.

FIG. 14 is a flowchart of still another sky environment control method according to an embodiment of this application. This embodiment of this application is performed by a terminal. Referring to FIG. 14, the method includes the following operations:

1401: The terminal displays a sky environment control interface in a UGC editor, the sky environment control interface being configured for controlling a sky environment in a virtual scene.

An implementation process of operation 1401 is similar to implementation processes of the foregoing operation 201 and operation 301. Details are not described one by one herein again.

1402: The terminal obtains a change signal, a first environment parameter, and transition duration based on a sky environment change operation in the sky environment control interface.

In embodiments of this application, when a sky environment change event is customized, in addition to the change signal and the first environment parameter, the transition duration may further be set. The transition duration refers to duration required for changing a current sky environment in the virtual scene to a sky environment indicated by the first environment parameter, that is, duration required for transition from one sky environment to another sky environment.

In a possible implementation, the sky environment includes a sky background and illumination, and the transition duration includes transition duration of the sky background and transition duration of the illumination. The transition duration of the sky background refers to duration of transition from a current sky background to a target sky background, and the transition duration of the illumination refers to duration of transition from current illumination to target illumination.

In some embodiments, the sky background and the illumination have uniform transition duration (that is, transition duration of the environment parameter is uniformly set), or the sky background and the illumination have respective transition duration, that is, the transition duration of the sky background and the transition duration of the illumination may be different.

In some embodiments, the transition duration may be measured in a unit of a frame, or may be measured in a time unit, for example, may be measured in a unit of a second.

As shown in FIG. 8, in a sky background editing sub-interface, an editing box 83 of the transition duration of the sky background is provided, and the user may set the transition duration of the sky background in the editing box. In addition, the sky background editing sub-interface further provides a setting box 84 of a sky transition effect. The sky transition effect is configured for indicating a dynamic effect of transition from the current sky background to the target sky background. As shown in FIG. 9, in an illumination editing sub-interface, an editing box 96 of the transition duration of the illumination is provided, and the transition duration of the illumination may be set in the editing box.

1403: The terminal changes, in response to the change signal triggered in the virtual scene, in a manner of transitional change and within the transition duration, the current sky environment in the virtual scene to the sky environment indicated by the first environment parameter.

If detecting in the virtual scene that the change signal is triggered, the terminal changes, in a manner of transition change and within the transition duration, the sky environment in the virtual scene to the sky environment indicated by the first environment parameter, to automatically trigger the sky environment change event in the virtual scene, thereby achieving a presentation effect of dynamically changing the sky environment in the virtual scene.

In some embodiments, time points at which different parameters in the first environment parameter start to change are different, or time points at which different parameters in the first environment parameter start to change are different. For example, when the first environment parameter includes a sky background and illumination, the sky background may be first switched, and then illumination is switched, or the illumination is first switched, and then the sky background is switched.

In a possible implementation, the sky environment includes a sky background and illumination, and the sky background and the illumination may be changed at the same time. The first environment parameter includes a first sky background parameter and a first illumination parameter. The transition duration includes transition duration of the sky background and transition duration of the illumination, that is, the sky background and the illumination respectively correspond to respective transition duration. In this case, the terminal changes, in the transition duration of the sky background, the sky background of the virtual scene to a sky background indicated by the first sky background parameter, and changes, in the transition duration of the illumination, the illumination of the virtual scene to illumination indicated by the first illumination parameter.

In some embodiments, a time point at which the sky background starts to change is the same as a time point at which the illumination starts to change, and when the transition duration of the sky background and the transition duration of the illumination are different, a time point at which the sky background completes changing is different from a time point at which the illumination completes changing.

In a possible implementation, in response to the change signal triggered in the virtual scene, the terminal determines an image refresh interval of the virtual scene, obtains a third environment parameter of a sky environment in the virtual scene, and determines an environment parameter of each frame of image within the transition duration based on the transition duration, the image refresh interval, the third environment parameter, and the first environment parameter, an environment parameter of the first frame of image within the transition duration being the third environment parameter, and an environment parameter of the last frame of image within the transition duration being the first environment parameter. The terminal sequentially displays each frame of image based on the environment parameter of each frame of image within the transition duration according to the image refresh interval.

The third environment parameter refers to an environment parameter of the current sky environment in the virtual scene.

The image refresh interval is a reciprocal of an image refresh rate. For example, when the image refresh rate is 50 Hz, that is, the image is refreshed for 50 times per second, the image refresh interval is 20 ms.

In a possible implementation, when the transition duration is in a unit of time, the terminal determines a transition frame quantity based on the transition duration and the image refresh interval, that is, determines a quantity of frames of an image that needs to be refreshed within the transition duration.

In another possible implementation, when the transition duration is in a unit of a frame, that is, when the transition duration is the transition frame quantity, the terminal may directly determine the transition frame quantity as the quantity of frames of the image that needs to be refreshed within the transition duration.

In a transition change process, an environment parameter of a sky environment in the first frame of image is the third environment parameter, that is, an environment parameter of the image at a time point at which the change starts, and an environment parameter of a sky environment in the last frame of image is the first environment parameter, that is, an environment parameter of the image at a time point at which the change completes. However, an environment parameter of an image between the first frame of image to the last frame of image is an environment parameter between the third environment parameter and the first environment parameter, to achieve an effect of transition from a sky environment indicated by the third environment parameter to a sky environment indicated by the first environment parameter.

In some embodiments, the terminal determines, in a manner of linear interpolation, an environment parameter of each frame of image within the transition duration based on the transition duration, the image refresh interval, the third environment parameter, and the first environment parameter. The terminal obtains the environment parameter of the sky environment in each transition frame through calculation by means of linear interpolation based on the third environment parameter, the first environment parameter, and the transition frame quantity.

Using a directional light source intensity as an example, the terminal determines the directional light source intensity of each frame of image by using the following formula.

$${LI}_{t} = {LI}_{Start} + \frac{t}{T} ( {LI}_{End} - {LI}_{Start} )$$

T represents the transition duration, t is a value not greater than T, LIₜ represents a directional light source intensity of the sky environment at duration t after the change starts, LIₛₜₐᵣₜ represents a directional light source intensity of the sky environment at the time point at which the change starts, that is, a directional light source intensity in the third environment parameter, and LI_{End} represents a directional light source intensity of the sky environment at the time point at which the change completes, that is, a directional light source intensity in the first environment parameter.

In a possible implementation, the terminal changes the sky environment by using an animation driving timer. FIG. 15 is a schematic diagram of processing logic of an animation driving timer according to an embodiment of this application. As shown in FIG. 15, a terminal determines timer duration and a callback interval of the animation driving timer based on an image refresh rate and transition duration. The timer duration refers to working duration of the animation driving timer, and the timer duration T is equal to the transition duration T. The callback interval is the image refresh interval, and the callback interval is equal to 1000/FPS, in a unit of millisecond (ms), where FPS is the image refresh rate. On Tick of the animation driving timer refers to a heartbeat pulse of an animation. In each On Tick, the sky environment is updated once, to be specific, the sky background and the illumination in the virtual scene are updated once, until the transition duration is reached, the sky background in the virtual scene becomes the sky background indicated by the first sky background parameter, and the illumination in the virtual scene becomes the illumination indicated by the first illumination parameter, thereby completing one change of the sky environment.

According to the method provided in embodiments of this application, the user may further configure the transition duration in the sky environment control interface, and when the change signal is triggered in the virtual scene, the sky environment in the virtual scene is automatically changed to the sky environment indicated by the environment parameter within the transition duration. In other words, the user may freely configure the transition duration for changing the sky environment, and different effects may be presented with different transition duration, thereby enriching presentation forms of changing the sky environment, further improving flexibility of changing the sky environment, improving smoothness of the sky environment change process, and avoiding sudden change of the sky environment when the change signal is triggered.

In a possible implementation, when gradual change is adopted for the current sky environment, that is, when the current sky environment is gradually changed into a target sky environment within the transition duration, in a process of setting a sky environment change event, a pause changing signal may be additionally set, to control the sky change progress by using the pause changing signal.

FIG. 16 is a flowchart of yet another sky environment control method according to an embodiment of this application. This embodiment of this application is performed by a terminal. Referring to FIG. 16, the method includes the following operations:

1601: The terminal displays a sky environment control interface in a UGC editor, the sky environment control interface being configured for controlling a sky environment in a virtual scene.

An implementation process of operation 1601 is similar to implementation processes of the foregoing operation 201 and operation 301. Details are not described one by one herein again.

1602: The terminal obtains a change signal, a first environment parameter, and a pause changing signal based on a sky environment change operation in the sky environment control interface.

In embodiments of this application, when the sky environment change event is customized, in addition to the change signal and the first environment parameter, the pause changing signal may further be set. The pause changing signal is a signal configured for pausing changing of the sky environment. The pause changing signal may be triggered based on a specific trigger condition. In some embodiments, the trigger condition may include a manual operation trigger condition (for example, a player triggers the pause changing signal by using a particular manual operation), a voice trigger condition (for example, a player triggers the pause changing signal by using particular voice), an event trigger condition (for example, a particular event in the virtual scene triggers the pause changing signal), and the like. This is not limited in the embodiments.

The pause changing signal is a signal customized by the user or a signal selected by the user from preset signals provided by the UGC editor, and the pause changing signal may be formed by a text, a number, a letter, or a symbol. As shown in FIG. 6, a signal editing area is displayed in a change event editing sub-interface. The signal editing area includes a “pause changing signal” editing box 63, and the user may customize a pause changing signal in the “pause changing signal” editing box.

1603: The terminal changes, in response to the change signal triggered in the virtual scene, a current sky environment in the virtual scene to a sky environment indicated by the first environment parameter.

In embodiments of this application, one sky environment is not directly replaced with another sky environment. Instead, it takes duration for the sky environment in the virtual scene to be changed to the sky environment indicated by the first environment parameter. For example, in the foregoing embodiment of FIG. 14, the sky environment in the virtual scene is changed to the sky environment indicated by the first environment parameter within the transition duration.

1604: In the process of changing the current sky environment in the virtual scene to the sky environment indicated by the first environment parameter, the terminal stops, in response to the pause changing signal triggered in the virtual scene, changing the current sky environment in the virtual scene to the sky environment indicated by the first environment parameter.

In the process of changing the current sky environment in the virtual scene to the sky environment indicated by the first environment parameter and when the change is not completed, if detecting that the pause changing signal is triggered in the virtual scene, the terminal stops changing the current sky environment in the virtual scene to the sky environment indicated by the first environment parameter, and remains a current change progress.

For example, using an example in which the sky environment in the virtual scene before changing is a sky environment A, and the sky environment indicated by the first environment parameter is a sky environment B, in a process of changing the sky environment A to the sky environment B and when the change is not completed, if it is detected that a pause changing signal is triggered in the virtual scene, and a current sky environment is a sky environment C, the change is stopped, and the sky environment in the virtual scene remains as the sky environment C. The sky environment C is a state between the sky environment A and the sky environment B, that is, a sky environment generated in the process of transition from the sky environment A to the sky environment B.

In a possible implementation, any change signal, any pause changing signal, and a corresponding environment parameter are stored in a form of a sky environment change event. For example, each sky environment change event corresponds to a change event identifier, and the change event identifier, the change signal, the pause changing signal, and the environment parameter are stored in association. In response to any signal triggered in the virtual scene, the terminal matches the signal with a signal corresponding to each change event identifier, and if determining that the signal is a pause changing signal corresponding to a change event identifier, the terminal determines whether the sky environment is being changed to a sky environment indicated by an environment parameter corresponding to the change event identifier. If yes, the terminal stops changing to the sky environment indicated by the environment parameter; if not, no processing needs to be performed.

In some embodiments, each created sky environment change event corresponds to an event status, and the event status includes an unchanged state, a changing state, and a pause changing state. The event status and the change event identifier, the change signal, the pause changing signal, the environment parameter, and the like of the sky environment change event are stored in correspondence. In response to any signal triggered in the virtual scene, the terminal matches the signal with a signal corresponding to each change event identifier, and if determining that the signal is a pause changing signal corresponding to a change event identifier, the terminal determines whether an event status corresponding to the change event identifier is a changing state. If yes, the terminal stops changing; if not, no processing needs to be performed.

1605: The terminal continues, in response to the change signal triggered again in the virtual scene, to change from a progress where the change previous stopped to the sky environment indicated by the first environment parameter.

After the change from the current sky environment in the virtual scene to the sky environment indicated by the first environment parameter is paused, if the change signal is triggered again, the terminal continues to change to the sky environment indicated by the first environment parameter from a progress where the change paused previously.

For example, using an example in which the sky environment in the virtual scene before changing is a sky environment A, and the sky environment indicated by the first environment parameter is a sky environment B, in the change process, if a pause changing signal is triggered, the change is paused, and a change progress of the pause is a sky environment C. When a change signal is triggered again, the change is started from the sky environment C, and the sky environment C continues to be changed to the sky environment B.

In a possible implementation, the event status of the sky environment change event includes an unchanged state, a changing state, and a pause changing state. In response to any signal triggered in the virtual scene, the terminal matches the signal with a signal corresponding to each change event identifier. If determining that the signal is a change signal corresponding to at least one change event identifier, the terminal determines whether there is a change event identifier whose event status is the pause changing state in the at least one change event identifier. If yes, the terminal preferentially executes a sky environment change event corresponding to the change event identifier whose event status is the pause changing state, that is, continues to change from a paused progress; if not, the terminal adds the sky environment change event to a waiting queue for processing according to the method in operation 304.

In some embodiments, when the sky environment starts to change, the terminal determines an environment parameter of the sky environment in each transition frame, to obtain a series of environment parameter sequences. When receiving a pause changing signal, the terminal sets a pause pointer in the environment parameter sequence based on an environment parameter corresponding to a pause moment. When receiving the change signal and resuming changing the sky environment, the terminal starts from the pause pointer, and performs change of the sky environment based on the environment parameter in the environment parameter sequence.

According to the method provided in embodiments of this application, a user may further configure the pause changing signal in the sky environment control interface. In a process of changing the sky environment, if the pause changing signal is triggered in the virtual scene, the change is automatically paused, and a current change progress remains unchanged. When the change signal is triggered again, the change is continued from the progress where the change paused. In other words, a function of interrupting the process of changing the sky environment is provided, and the user may freely configure an occasion of pausing changing of the sky environment, thereby enriching presentation forms of changing the sky environment, and further improving the flexibility of changing the sky environment.

In a possible implementation, the sky environment change may alternatively interact with a particular event in the virtual scene. In other words, when the sky environment change is completed, the particular event in the virtual scene may be triggered, to form a link between the sky environment change event and a scene event.

FIG. 17 is a flowchart of yet another sky environment control method according to an embodiment of this application. This embodiment of this application is performed by a terminal. Referring to FIG. 17, the method includes the following operations:

1701: The terminal displays a sky environment control interface in a UGC editor, the sky environment control interface being configured for controlling a sky environment in a virtual scene.

An implementation process of operation 1701 is similar to implementation processes of the foregoing operation 201 and operation 301. Details are not described one by one herein again.

1702: The terminal obtains a change signal, a first environment parameter, and an end signal based on a sky environment change operation in the sky environment control interface.

In embodiments of this application, when a sky environment change event is customized, in addition to the change signal and the first environment parameter, the end signal may further be set. The end signal is configured to be automatically triggered after changing of the sky environment is completed, and the user may further customize to start a particular event in the virtual scene when the end signal is triggered. The end signal is a signal customized by the user or a signal selected by the user from preset signals provided by the UGC editor, and the change signal may be formed by a text, a number, a letter, or a symbol. As shown in FIG. 6, a signal editing area is displayed in a change event editing sub-interface. The signal editing area includes an “end signal” editing box 64, and the user may customize an end signal in the “end signal” editing box 64.

In some embodiments, the particular event triggered by the end signal may be a candidate event in the virtual scene, or may be an event customized by the user. This is not limited in the embodiments.

1703: The terminal changes, in response to the change signal triggered in the virtual scene, a sky environment in the virtual scene to a sky environment indicated by the first environment parameter.

An implementation process of operation 1703 is similar to an implementation process of the foregoing operation 203. Details are not described herein again.

1704: The terminal triggers the end signal in the virtual scene when changing to the sky environment indicated by the first environment parameter.

Because the user further configures the end signal while configuring the change signal and the first environment parameter, after the sky environment is changed to the sky environment indicated by the first environment parameter, the end signal is automatically triggered in the virtual scene. In other words, a trigger condition of the end signal is: completely changing the sky environment to the sky environment indicated by the first environment parameter. In addition, the user may further customize to start a particular event in the virtual scene when the end signal is triggered. In other words, the end signal is automatically triggered after the sky environment is changed to the sky environment indicated by the first environment parameter, and the particular event is automatically started after the end signal is triggered. This is equivalent to that the particular event may be automatically triggered after the sky environment is changed to the sky environment indicated by the first environment parameter.

In a schematic example, the environment parameter in the sky environment change event indicates to change the sky environment to a night sky, and the end signal in the sky environment change event is configured for triggering a lights-on event in the virtual scene. By using the sky environment change event, after the sky environment is changed to the night sky, lights in buildings in the virtual scene can be automatically turned on.

According to the method provided in embodiments of this application, the user may further configure the end signal in the sky environment control interface, and automatically trigger the end signal in the virtual scene after the sky environment is changed to the sky environment indicated by the first environment parameter. The user may further customize which event to start in the virtual scene when the end signal is triggered. It is equivalent to that the user may customize that a particular event can be automatically started after the sky environment is changed once, thereby enhancing a freedom degree of controlling the virtual scene by the user, and enriching virtual scene control manners.

FIG. 18 is a flowchart of a signal control method in a virtual scene according to an embodiment of this application. This embodiment of this application is performed by a terminal. Referring to FIG. 18, the method includes the following operations:

1801: The terminal displays a signal control interface in a UGC editor, the signal control interface being configured for controlling a signal in the virtual scene.

A game application runs on the terminal. The game application has a UGC editor. The UGC editor is further configured to control a signal in the virtual scene. The signal control interface is provided in the UGC editor. The signal control interface is configured for controlling the signal in the virtual scene, for example, a change signal or a pause changing signal in the foregoing embodiments. In embodiments of this application, the change signal is used as an example, and a process of triggering the change signal is described in detail.

1802: The terminal obtains the change signal and a trigger condition corresponding to the change signal based on a signal editing operation in the signal control interface.

If the user expects to customize a signal triggering event in the virtual scene, for example, customize an event for triggering a change signal, the user may perform the signal editing operation on the signal control interface to set the change signal and a trigger condition corresponding to the change signal, and the terminal may obtain, based on the signal editing operation, the change signal and the trigger condition that are set by the user.

The trigger condition is a condition for triggering the change signal. In some embodiments, the trigger condition may be a particular event in the virtual scene or a particular operation received by the terminal.

For example, the trigger condition is that: a virtual object enters a target area in the virtual scene (that is, an entry event in the virtual scene), or a virtual object touches a target item in the virtual scene (that is, an item touch event), or a time point in the virtual scene reaches a target time point (that is, a mission complete event), or duration for which a virtual object is in the virtual scene reaches target duration (that is, a stay duration event), or the terminal receives a specific voice instruction, or the like. The trigger condition may be customized by the user, or may be selected by the user from preset trigger conditions provided by the UGC editor. This is not limited in embodiments of this application.

In a possible implementation, the signal control interface includes a signal editing area and a trigger condition editing area, and the terminal obtains the change signal based on an editing operation in the signal editing area, and obtains the trigger condition based on an editing operation in the trigger condition editing area.

1803: The terminal triggers the change signal in the virtual scene when the trigger condition is satisfied.

When detecting that the trigger condition is currently satisfied, the terminal automatically triggers the change signal in the virtual scene, and further, as described in the foregoing embodiments, after the change signal is triggered in the virtual scene, the sky environment can be automatically changed.

According to the method provided in embodiments of this application, the UGC editor is provided in the game application. The UGC editor integrates, in the sky environment control interface, a function of controlling the signal in the virtual scene. The user may configure the change signal and the trigger condition on the signal control interface. When the trigger condition is satisfied in the virtual scene, the change signal can be automatically triggered in the virtual scene, thereby flexibly controlling a trigger occasion of the change signal. The change signal is configured for starting to change the sky environment in the virtual scene, which is equivalent to that the user can flexibly control an occasion of changing the sky environment in the virtual scene.

In addition, one change signal may correspond to a plurality of sky environment change events, or one change signal may even correspond to a plurality of events of different types, so that events in the virtual scene are flexibly controlled by controlling the trigger condition of the change signal, thereby improving the flexibility and convenience of controlling the virtual scene.

FIG. 19 is a flowchart of a change event control method according to an embodiment of this application. This embodiment of this application is performed by a terminal. Referring to FIG. 19, the method includes the following operations:

1901: The terminal displays a sky environment control interface in a UGC editor, the sky environment control interface being configured for controlling a sky environment in a virtual scene.

An implementation process of operation 1901 is similar to implementation processes of the foregoing operation 201 and operation 301. Details are not described one by one herein again.

1902: The terminal obtains a change signal, a first environment parameter, and a change event identifier based on a sky environment change operation in the sky environment control interface, the change event identifier indicating a change event formed by a change signal and an environment parameter

In embodiments of this application, when the sky environment change event is customized, in addition to the change signal and the first environment parameter, the change event identifier may further be set. The change event identifier indicates the sky environment change event formed by the change signal and the first environment parameter. The terminal correspondingly stores the change event identifier of the sky environment change event, the change signal, and the first environment parameter.

The change event identifier is an identifier customized by the user or an identifier selected by the user from preset identifiers provided by the UGC editor, and the change event identifier may be formed by a text, a number, a letter, or a symbol. As shown in FIG. 6, a signal editing area is displayed in the change event editing sub-interface. The signal editing area includes a “name” editing box 61, and the user may customize the change event identifier in the “name” editing box 61.

1903: The terminal displays a created change event identifier on the sky environment control interface.

In a possible implementation, the terminal further displays a deletion option, an editing option, and a viewing option of the created change event identifier. The deletion option is configured for deleting a change event indicated by the change event identifier, to be specific, deleting information such as the change event identifier, the change signal, and the first environment parameter of the sky environment change event.

The editing option is configured for editing the change event indicated by the change event identifier, to be specific, editing information such as the change event identifier, the change signal, and the first environment parameter of the sky environment change event. An editing manner is the same as the manner of creating the sky environment change event in the foregoing embodiments.

The viewing option is configured for viewing the change event indicated by the change event identifier, to be specific, viewing information such as the change event identifier, the change signal, and the first environment parameter of the sky environment change event.

In a possible implementation, the terminal displays the created change event identifier and an event status corresponding to each created change event identifier on the sky environment control interface, the event status including an unchanged state, a changing state, and a pause changing state. The unchanged state means that a process of changing the current sky environment to the sky environment indicated by the environment parameter in the sky environment change event is not being executed currently. The changing state indicates that the process of changing the sky environment to the sky environment indicated by the environment parameter in the sky environment change event is being executed currently. The pause changing state means that the process of changing the current sky environment to the sky environment indicated by the environment parameter in the sky environment change event is paused during execution.

In embodiments of this application, the event status corresponding to the created change event identifier is displayed, so that it is convenient for the user to learn a change situation of the current sky environment, and it is convenient for the user to manage the sky environment change event.

1904: The terminal displays, in response to a trigger operation on the change event identifier, the change signal and the environment parameter in the change event indicated by the change event identifier.

If the user expects to view a change signal and an environment parameter that correspond to a change event identifier, the user performs a trigger operation on the change event identifier, so that the terminal displays the change signal and the environment parameter in the change event indicated by the change event identifier. In another embodiment, the terminal further displays a viewing option corresponding to the created change event identifier. The terminal displays, in response to a trigger operation on a viewing option on any change event identifier, a change signal and an environment parameter in a change event indicated by the change event identifier. In addition, besides the change signal and the environment parameter, the terminal may further display other information in the change event, such as a pause changing signal and an end signal.

In a possible implementation, the terminal displays, in the sky environment control interface, a change viewing option, and a change signal and an environment parameter that are in a change event with the earliest creation time. The terminal displays a plurality of created change event identifiers in response to a trigger operation on the viewing option. The terminal replaces, in response to a trigger operation on the change event identifier, a currently displayed change signal and environment parameter with the change signal and the environment parameter in the change event indicated by the change event identifier.

FIG. 20 is a schematic diagram of another sky environment control interface according to an embodiment of this application. As shown in FIG. 20, when a user performs a trigger operation on a change viewing option in the sky environment control interface, a terminal displays a change event identifier list 2001 in the sky environment control interface. The change event identifier list 2001 includes change event identifiers of created sky environment change events, which are respectively “sky environment change 1”, “sky environment change 2”, “illumination change 3”, and “sky environment change 4”.

In some embodiments, when receiving trigger operations on at least two change event identifiers, the terminal may compare and display change events indicated by the change event identifiers, so that the user can modify a plurality of change events at the same time.

According to the method provided in embodiments of this application, the created change event identifiers and a deletion option, a viewing option, an editing option, and an event status that correspond to each change event identifier are displayed in the sky environment control interface, and logic of each sky environment change event is independently maintained, reducing difficulty in performing secondary modification on a sky environment change event by the user, and naming of each sky environment change event is supported, thereby facilitating management by the user.

FIG. 21 is a flowchart of yet another sky environment control method according to an embodiment of this application. This embodiment of this application is performed by a terminal. Referring to FIG. 21, the method includes the following operations:

2101: The terminal displays a sky environment control interface in a UGC editor, the sky environment control interface being configured for controlling a sky environment in a virtual scene.

An implementation process of operation 2101 is similar to implementation processes of the foregoing operation 201 and operation 301. Details are not described one by one herein again.

2102: The terminal obtains a second environment parameter based on an editing operation in the sky environment editing sub-interface.

The sky environment control interface includes a sky environment editing option. The sky environment editing option is configured for triggering a sky environment editing sub-interface, and the sky environment editing sub-interface is configured for editing a current sky environment in the virtual scene, that is, setting an environment parameter of the current sky environment.

In some embodiments, the second environment parameter includes a parameter corresponding to at least one element affecting a sky status in the virtual scene.

In a possible implementation, the sky environment editing sub-interface includes a preset option and a custom option. That the terminal obtains the second environment parameter based on the editing operation in the sky environment editing sub-interface includes the following two manners:

Manner 1: The terminal obtains a preset environment parameter in response to a trigger operation on the preset option. If the user expects to set the environment parameter to the preset environment parameter provided by the UGC editor, the user performs the trigger operation on the preset option, and the preset environment parameter is the second environment parameter.

In some embodiments, the environment parameters include a sky background parameter and an illumination parameter, and the terminal obtains, in response to the trigger operation on the preset option, a current sky background parameter and a preset illumination parameter corresponding to the sky background parameter. The preset illumination parameter corresponding to the sky background parameter refer to a preset illumination parameter corresponding to a sky background image in the sky background parameter, and each sky background image corresponds to a set of preset illumination parameter.

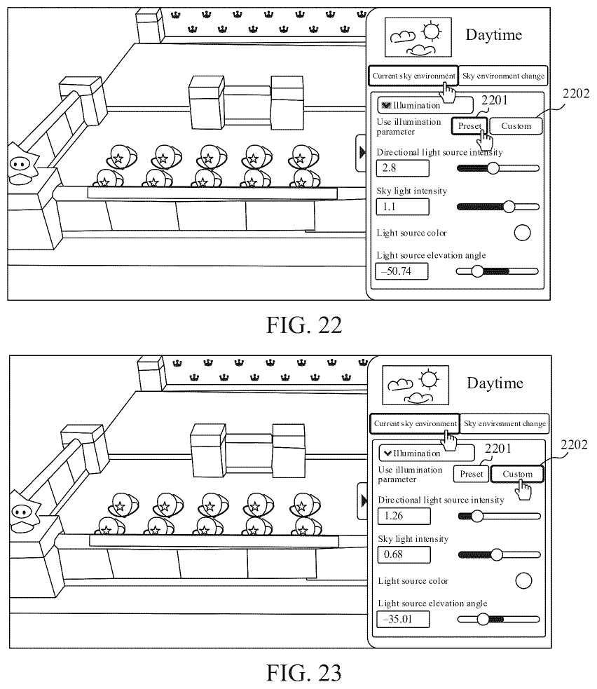

FIG. 22 is a schematic diagram of a sky environment editing sub-interface according to an embodiment of this application. As shown in FIG. 22, the sky environment editing sub-interface includes a preset option 2201 and a custom option 2202. When a user triggers the preset option 2201, a preset illumination parameter is displayed on the sky environment editing sub-interface. In the preset illumination parameter, a directional light source intensity is 2.8, a sky light intensity is 1.1, a light source color is white, and a light source elevation angle is −50.74.

Manner 2: The terminal obtains, in response to a trigger operation on the custom option, an environment parameter determined based on a user operation. If the user expects to customize the environment parameter, a trigger operation on the custom option is performed, the user may set the environment parameter in the sky environment editing sub-interface, and the terminal may obtain the environment parameter set by the user. The environment parameter is the second environment parameter.

Using an example in which the user customizes the illumination parameter in the environment parameter, FIG. 23 is a schematic diagram of another sky environment editing sub-interface according to embodiment of this application. As shown in FIG. 23, the sky environment editing sub-interface includes a preset option 2201 and a custom option 2202. When the user triggers the custom option 2202, the sky environment editing sub-interface displays the illumination parameter set by the user. The user may input the illumination parameter in an input box, or may set the illumination parameter by dragging a slide bar. Referring to FIG. 23, in the illumination parameter set by the user, a directional light source intensity is 1.26, a sky light intensity is 0.68, a light source color is white, and a light source elevation angle is −35.01.

In embodiments of this application, the two manners in which the preset environment parameter is used and the customized environment parameter is used are provided. The preset environment parameter refers to an environment parameter provided by the UGC editor, that is, an environment parameter provided by an application developer. The customized environment parameter refers to an environment parameter set by the user. The environment parameter set by the user may cover the preset environment parameter, that is, a sky environment indicated by the environment parameter set by the user is presented in the virtual scenario. The UGC editor stores two sets of parameters: the preset environment parameter and the customized environment parameter, so that the user compares the customized environment parameter with the preset environment parameter, and the user is assisted in making a configuration that conforms to an expectation of the user in the process of controlling the sky environment. In addition, the user may match the preset environment parameter with the customized environment parameter, thereby increasing convenience and a freedom degree for the user to control the sky environment.

In a possible implementation, operation 2102 includes at least one of the following:

(1) The terminal obtains a second sky background parameter based on a sky background editing operation in the sky environment editing sub-interface. An implementation of this operation is similar to that of the foregoing operation 3032, and details are not described herein again.

(2) The terminal obtains a second illumination parameter based on an illumination editing operation in the sky environment editing sub-interface. An implementation of this operation is similar to that of the foregoing operation 3033, and details are not described herein again.

The second environment parameter includes at least one of the second sky background parameter or the second illumination parameter. The terminal performs at least one of the foregoing (1) or (2), to obtain at least one of the second sky background parameter or the second illumination parameter, to form the second environment parameter.

In embodiments of this application, elements in the sky environment are divided into the sky background and the illumination. The user may select to edit at least one of the sky background or the illumination, that is, editing of the sky background and the illumination can be completed at one time, to satisfy effect requirements for different sky environments in various virtual scenes. The user can freely match different sky background effects and illumination effects, thereby further improving flexibility in controlling the sky environment.

2103: The terminal changes the sky environment in the virtual scene to a sky environment indicated by the second environment parameter.

After obtaining the second environment parameter for editing the sky environment, the terminal changes the sky environment in the virtual scene to the sky environment indicated by the second environment parameter.

A difference between embodiments of this application and the foregoing embodiment of FIG. 3 lies in that: after the change signal and the environment parameter are edited, in the foregoing embodiment of FIG. 3, the change is automatically performed based on the environment parameter when the change signal is triggered, while in embodiments of this application, after the environment parameter is edited, the change is directly performed based on the environment parameter.

In some embodiments, in a process of editing the second environment parameter, the terminal may dynamically update the sky environment based on a real-time environment parameter in the editing process, so that the user views an effect of the sky environment in real time, thereby improving environment parameter setting efficiency.

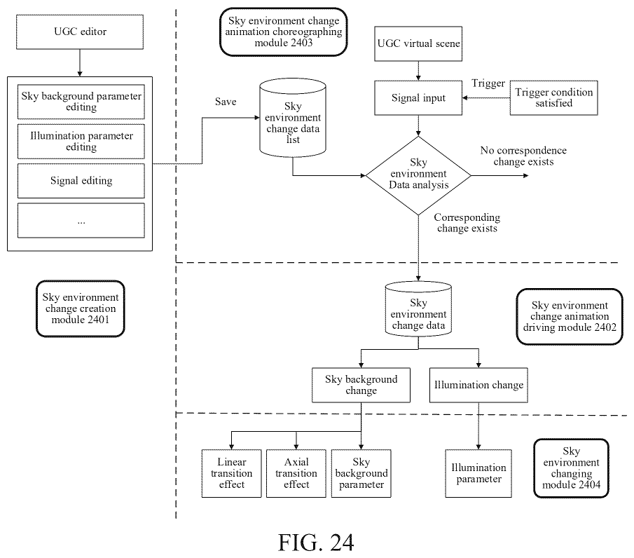

FIG. 24 is a diagram of a system architecture of a sky environment control method according to an embodiment of this application. As shown in FIG. 24, the system of the sky environment control method includes four parts, which are respectively: a sky environment change creation module 2401, a sky environment change animation driving module 2402, a sky environment change animation choreographing module 2403, and a sky environment changing module 2404. In terms of overall design, the sky environment change creation module 2401 is responsible for editing and generating sky environment change data. The sky environment change animation driving module 2402 and the sky environment change animation choreographing module 2403 are responsible for understanding the sky environment change data, and determining an environment parameter of each image. The sky environment changing module 2404 is responsible for performing rendering based on the environment parameter, to generate a final image effect. Each module is described below in detail.

1. Sky environment change creation module The sky environment change creation module includes a UGC editor configured to: edit sky environment change data such as a sky background parameter, an illumination parameter, and a signal (including a change signal, a pause changing signal, an end signal, and the like), and save the sky environment change data in a sky environment change data list. The editor includes a sky background setting interface, an illumination setting interface, a change addition interface, a change deletion interface, a signal modification interface, a sky background modification interface, an illumination modification interface, and a save interface. The sky background setting interface is configured for adjusting a sky background in a virtual scene. The illumination setting interface is configured for adjusting illumination in the virtual scene. The change addition interface is configured for creating the sky environment change data. The change deletion interface is configured for deleting the sky environment change data. The signal modification interface is configured for setting the change signal, the pause changing signal, and the end signal. The sky background modification interface is configured for setting transition duration and a sky background parameter when change is completed. The illumination modification interface is configured for setting an illumination parameter when change is completed. The save interface is configured for applying the sky environment change data to the virtual scene, to present a corresponding change effect in the virtual scene. In addition, the sky environment change creation module further provides a preview interface, and the preview interface is configured for previewing a change effect corresponding to a sky environment change data that is being edited currently.

2. Sky environment change animation driving module The sky environment change animation driving module is configured to determine an environment parameter, for example, a sky background parameter required by sky background change and an illumination parameter required by illumination change, of a sky environment in each frame of image based on the sky environment change data. The sky environment change animation driving module includes the animation driving timer shown in FIG. 15.

3. Sky environment change animation choreographing module The sky environment change animation choreographing module is responsible for a choreography status of a sky environment change event. When a trigger condition is satisfied in the UGC virtual scene, a corresponding signal is input. The sky environment change animation choreographing module analyzes the signal based on the sky environment change data list, to determine whether there is a corresponding change. If there is a corresponding change, the sky environment change animation driving module performs animation driving,
for example, triggers the sky environment change event, pauses the sky environment change event, and restores the sky environment change event.

4. Sky environment changing module The sky environment changing module is configured to modify parameters of a sky background component and an illumination component in the virtual scene. The sky background change involves a sky background parameter and a transition effect, the transition effect includes a linear transition effect and an axial transition effect, and the illumination change involves an illumination parameter. The sky environment changing module includes a sky background image setting interface, a directional light source intensity setting interface, a light source color setting interface, a sky light intensity setting interface, a light source pitch angle setting interface, a light source yaw angle setting interface, and the like.

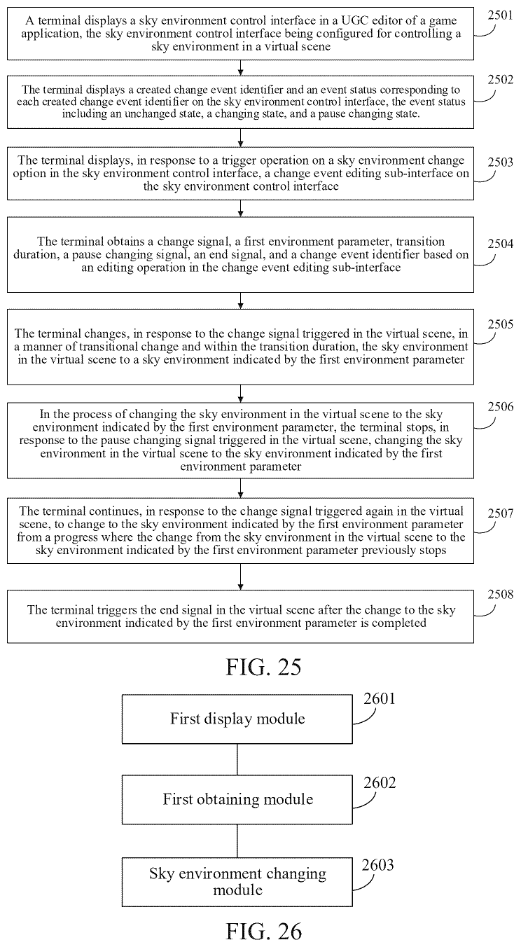

FIG. 25 is a flowchart of yet another sky environment control method according to an embodiment of this application. The method includes the following operations.

2501: A terminal displays a sky environment control interface in a UGC editor of a game application, the sky environment control interface being configured for controlling a sky environment in a virtual scene.

2502: The terminal displays a created change event identifier and an event status corresponding to each created change event identifier on the sky environment control interface, the event status including an unchanged state, a changing state, and a pause changing state.

2503: The terminal displays, in response to a trigger operation on a sky environment change option in the sky environment control interface, a change event editing sub-interface on the sky environment control interface.

2504: The terminal obtains a change signal, a first environment parameter, transition duration, a pause changing signal, an end signal, and a change event identifier based on an editing operation in the change event editing sub-interface.

2505: The terminal changes, in response to the change signal triggered in the virtual scene, in a manner of transitional change and within the transition duration, the sky environment in the virtual scene to a sky environment indicated by the first environment parameter.

2506: In the process of changing the sky environment in the virtual scene to the sky environment indicated by the first environment parameter, the terminal stops, in response to the pause changing signal triggered in the virtual scene, changing the sky environment in the virtual scene to the sky environment indicated by the first environment parameter.

2507: The terminal continues, in response to the change signal triggered again in the virtual scene, to change to the sky environment indicated by the first environment parameter from a progress where the change from the sky environment in the virtual scene to the sky environment indicated by the first environment parameter previously stops.

2508: The terminal triggers the end signal in the virtual scene after the change to the sky environment indicated by the first environment parameter is completed.

FIG. 26 is a schematic structural diagram of a sky environment control apparatus according to an embodiment of this application. The apparatus includes:
a first display module 2601, configured to display a sky environment control interface in a UGC editor, the sky environment control interface being configured for managing a sky environment in a virtual scene;
a first obtaining module 2602, configured to obtain, based on a sky environment change operation in the sky environment control interface, a change signal and a first environment parameter corresponding to the change signal; and
a sky environment changing module 2603, configured to change, in response to the change signal triggered in the virtual scene, a current sky environment in the virtual scene to a sky environment indicated by the first environment parameter.

In some embodiments, the sky environment control interface includes a sky environment change option; and the first obtaining module 2602 is configured to:
display, in response to a trigger operation on the sky environment change option, a change event editing sub-interface on the sky environment control interface; and
obtain the change signal and the first environment parameter based on an editing operation in the change event editing sub-interface.

In some embodiments, the first obtaining module 2602 is configured to:
obtain the change signal based on a signal editing operation in the change event editing sub-interface;
obtain a first sky background parameter based on a sky background editing operation in the change event editing sub-interface; and
obtain a first illumination parameter based on an illumination editing operation in the change event editing sub-interface;
the first environment parameter including at least one of the first sky background parameter and the first illumination parameter.

In some embodiments, the first obtaining module 2602 is configured to obtain the change signal, the first environment parameter, and transition duration based on the sky environment change operation; and
the sky environment changing module 2603 is configured to change, in response to the change signal triggered in the virtual scene, in a manner of transitional change and within the transition duration, the current sky environment in the virtual scene to the sky environment indicated by the first environment parameter.

In some embodiments, the sky environment changing module 2603 is configured to:
determine an image refresh interval of the virtual scene in response to the change signal triggered in the virtual scene;
obtain a third environment parameter of the current sky environment in the virtual scene;
determine an environment parameter of each frame of image within the transition duration based on the transition duration, the image refresh interval, the third environment parameter, and the first environment parameter, an environment parameter of the first frame of image within the transition duration being the third environment parameter, and an environment parameter of the last frame of image within the transition duration being the first environment parameter; and
sequentially display each frame of image based on the environment parameter of each frame of image within the transition duration according to the image refresh interval.

In some embodiments, the first obtaining module 2602 is configured to obtain the change signal, the first environment parameter, and a pause changing signal based on the sky environment change operation; and
the sky environment changing module 2603 is further configured to: in the process of changing the sky environment in the virtual scene to the sky environment indicated by the first environment parameter, stop, in response to the pause changing signal triggered in the virtual scene, changing the current sky environment in the virtual scene to the sky environment indicated by the first environment parameter.

In some embodiments, the sky environment changing module 2603 is further configured to: continue, in response to the change signal triggered again in the virtual scene, to change from a progress where the change previous stopped to the sky environment indicated by the first environment parameter.

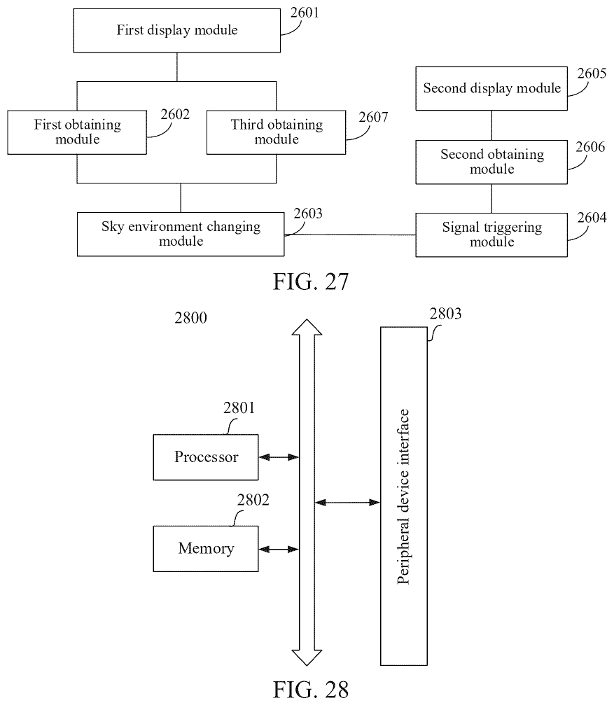

In some embodiments, referring to FIG. 27, the first obtaining module 2602 is configured to obtain the change signal, the first environment parameter, and an end signal based on the sky environment change operation; and
the apparatus further includes a signal triggering module 2604, configured to trigger the end signal in the virtual scene when changing to the sky environment indicated by the first environment parameter, the end signal being configured for triggering to start a particular event in the virtual scene.

In some embodiments, referring to FIG. 27, the UGC editor is further configured to control a signal in the virtual scene, and the apparatus further includes:
a second display module 2605, configured to display a signal control interface in the UGC editor, the signal control interface being configured for controlling a signal in the virtual scene;
a second obtaining module 2606, configured to obtain the change signal and a trigger condition corresponding to the change signal based on a signal editing operation in the signal control interface; and
a signal triggering module 2604, configured to trigger the change signal in the virtual scene when the trigger condition is satisfied.

In some embodiments, the first display module 2601 is further configured to:
display a created change event identifier on the sky environment control interface, the change event identifier being configured for indicating a change event formed by a change signal and an environment parameter; and
display, in response to a trigger operation on the change event identifier, the change signal and the environment parameter in the change event indicated by the change event identifier.

In some embodiments, the first display module 2601 is configured to display the created change event identifier and an event status corresponding to the created change event identifier on the sky environment control interface, the event status including an unchanged state, a changing state, and a pause changing state.

In some embodiments, referring to FIG. 27, the sky environment control interface includes a sky environment editing option; and the apparatus further includes:
a third obtaining module 2607, configured to: display, in response to a trigger operation on the sky environment editing option, a sky environment editing sub-interface on the sky environment control interface; and obtain a second environment parameter based on an editing operation in the sky environment editing sub-interface; and
the sky environment changing module 2603 is further configured to change the current sky environment in the virtual scene to a sky environment indicated by the second environment parameter.

In some embodiments, the sky environment editing sub-interface includes a preset option and a custom option; and the third obtaining module 2607 is configured to:
obtain a preset environment parameter in response to a trigger operation on the preset option; or
obtain, in response to a trigger operation on the custom option, an environment parameter determined based on a user operation.

In some embodiments, the third obtaining module 2607 is configured to implement at least one of the following:
obtaining a second sky background parameter based on a sky background editing operation in the sky environment editing sub-interface; or
obtaining a second illumination parameter based on an illumination editing operation in the sky environment editing sub-interface;
the second environment parameter including at least one of the second sky background parameter and the second illumination parameter.

The sky environment control apparatus provided in the foregoing embodiments is only exemplified by a division of the foregoing functional modules. In a practical application, the foregoing function allocation may be completed by different functional modules according to a need, in other words, an internal structure of the terminal is divided into different functional modules, to complete all or part of the functions described above. In addition, the sky environment control apparatus provided in the foregoing embodiments and the sky environment control method embodiments are based on the same concept. For details of a specific implementation process, refer to the method embodiments. Details are not described herein again.

Embodiments of this application further provide a terminal, including a processor and a memory, the memory having at least one computer program stored therein, and the at least one computer program being loaded and executed by the processor to implement the operations performed in the sky environment control method in the foregoing embodiments.

FIG. 28 is a schematic structural diagram of a terminal 2800 according to an exemplary embodiment of this application.

The terminal 2800 includes a processor 2801 and a memory 2802.

The processor 2801 may include one or more processing cores, for example, may be a 4-core processor or an 8-core processor. The processor 2801 may be implemented in at least one hardware form of a digital signal processor (DSP), a field programmable gate array (FPGA), or a programmable logic array (PLA). The processor 2801 may alternatively include a main processor and a co-processor. The main processor is a processor configured to process data in an awake state, and is also referred to as a central processing unit (CPU). The co-processor is a low-power-consumption processor configured to process data in a standby state. In some embodiments, the processor 2801 may be integrated with a graphics processing unit (GPU). The GPU is configured to render and draw content that needs to be displayed on a display screen. In some embodiments, the processor 2801 may further include an artificial intelligence (AI) processor. The AI processor is configured to process computing operations related to machine learning.

The memory 2802 may include one or more computer-readable storage media. The computer-readable storage medium may be non-transient. The memory 2802 may further include a high-speed random access memory, and may also include a non-volatile memory, for example, one or more magnetic disk storage devices or flash memory storage devices. In some embodiments, the non-transient computer-readable storage medium in the memory 2802 is configured to store at least one computer program, and the at least one computer program is configured to be executed by the processor 2801 to implement the sky environment control method provided in the method embodiments of this application.

In some embodiments, the terminal 2800 may alternatively include: a peripheral device interface 2803 and at least one peripheral device. The processor 2801, the memory 2802, and the peripheral device interface 2803 may be connected through a bus or a signal cable. Each peripheral may be connected to the peripheral device interface 2803 through a bus, a signal cable, or a circuit board. In some embodiments, the peripheral device includes at least one of a radio frequency circuit, a display screen, a camera assembly, an audio circuit, or a power supply.

The peripheral device interface 2803 may be configured to connect the at least one peripheral device related to input/output (I/O) to the processor 2801 and the memory 2802. In some embodiments, the processor 2801, the memory 2802 and the peripheral device interface 2803 are integrated on a same chip or circuit board. In some other embodiments, any one or two of the processor 2801, the memory 2802, and the peripheral device interface 2803 may be implemented on a single chip or circuit board. This is not limited in the embodiments.

A person skilled in the art may understand that the structure shown in FIG. 28 constitutes no limitation to the terminal 2800, and the terminal 2800 may include more or fewer components than those shown in the figure, or some components may be combined, or a different component deployment may be used.

Embodiments of this application further provide a non-transitory computer-readable storage medium. The computer-readable storage medium has at least one computer program stored therein. The at least one computer program is loaded and executed by a processor to implement the operations performed in the sky environment control method in the foregoing embodiments.

Embodiments of this application further provide a computer program product, including a computer program, the computer program being loaded and executed by a processor to implement the operations performed in the sky environment control method in the foregoing embodiments.

A person of ordinary skill in the art may understand that all or some of the steps of the foregoing embodiments may be implemented by hardware, or may be implemented by a program instructing relevant hardware. The program may be stored in a non-transitory computer-readable storage medium. The storage medium may be a read-only memory, a magnetic disk, an optical disc, or the like.

The foregoing descriptions are merely optional embodiments of embodiments of this application, and are not intended to limit embodiments of this application. Any modification, equivalent replacement, improvement, or the like made within the spirit and principle of embodiments of this application falls within the protection scope of this application. In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. A sky environment control method performed by a computer device, the method comprising:
displaying a sky environment control interface in a user generated content UGC editor;
obtaining, based on a sky environment change operation in the sky environment control interface, a change signal and a first environment parameter corresponding to the change signal; and
changing, in response to the change signal triggered in the virtual scene, a current sky environment in the virtual scene to a sky environment indicated by the first environment parameter.

2. The method according to claim 1, wherein the sky environment control interface comprises a sky environment change option; and the obtaining, based on a sky environment change operation in the sky environment control interface, a change signal and a first environment parameter corresponding to the change signal comprises:
displaying, in response to a trigger operation on the sky environment change option, a change event editing sub-interface on the sky environment control interface; and
obtaining the change signal and the first environment parameter based on an editing operation in the change event editing sub-interface.

3. The method according to claim 2, wherein the obtaining the change signal and the first environment parameter based on an editing operation in the change event editing sub-interface comprises:
obtaining the change signal based on a signal editing operation in the change event editing sub-interface;
obtaining a first sky background parameter based on a sky background editing operation in the change event editing sub-interface; and
obtaining a first illumination parameter based on an illumination editing operation in the change event editing sub-interface;
the first environment parameter comprising at least one of the first sky background parameter and the first illumination parameter.

4. The method according to claim 1, wherein the obtaining, based on a sky environment change operation in the sky environment control interface, a change signal and a first environment parameter corresponding to the change signal comprises:
obtaining the change signal, the first environment parameter, and transition duration based on the sky environment change operation; and
changing, in response to the change signal triggered in the virtual scene, in a manner of transitional change and within the transition duration, the current sky environment in the virtual scene to the sky environment indicated by the first environment parameter.

5. The method according to claim 4, wherein the changing, in response to the change signal triggered in the virtual scene, in a manner of transitional change and within the transition duration, the current sky environment in the virtual scene to the sky environment indicated by the first environment parameter comprises:
determining an image refresh interval of the virtual scene in response to the change signal triggered in the virtual scene;
obtaining a third environment parameter of the current sky environment in the virtual scene;
determining an environment parameter of each frame of image within the transition duration based on the transition duration, the image refresh interval, the third environment parameter, and the first environment parameter, an environment parameter of the first frame of image within the transition duration being the third environment parameter, and an environment parameter of the last frame of image within the transition duration being the first environment parameter; and
sequentially displaying each frame of image based on the environment parameter of each frame of image within the transition duration according to the image refresh interval.

6. The method according to claim 1, wherein the obtaining, based on a sky environment change operation in the sky environment control interface, a change signal and a first environment parameter corresponding to the change signal comprises:
obtaining the change signal, the first environment parameter, and a pause changing signal based on the sky environment change operation; and
in the process of changing the sky environment in the virtual scene to the sky environment indicated by the first environment parameter, stopping, in response to the pause changing signal triggered in the virtual scene, changing the current sky environment in the virtual scene to the sky environment indicated by the first environment parameter.

7. The method according to claim 6, wherein the method further comprises:
continuing, in response to the change signal triggered again in the virtual scene, to change from a progress where the change previous stopped to the sky environment indicated by the first environment parameter.

8. The method according to claim 1, wherein the obtaining, based on a sky environment change operation in the sky environment control interface, a change signal and a first environment parameter corresponding to the change signal comprises:
obtaining the change signal, the first environment parameter, and an end signal based on the sky environment change operation; and
triggering the end signal in the virtual scene when changing to the sky environment indicated by the first environment parameter, the end signal being configured for triggering to start a particular event in the virtual scene.

9. The method according to claim 1, wherein the method further comprises:
displaying a signal control interface in the UGC editor, the signal control interface being configured for controlling a signal in the virtual scene;
obtaining the change signal and a trigger condition corresponding to the change signal based on a signal editing operation in the signal control interface; and
triggering the change signal in the virtual scene when the trigger condition is satisfied.

10. The method according to claim 1, wherein the method further comprises:
displaying a created change event identifier on the sky environment control interface; and
displaying, in response to a trigger operation on the change event identifier, the change signal and the environment parameter in the change event indicated by the change event identifier.

11. The method according to claim 10, wherein the displaying a created change event identifier on the sky environment control interface comprises:
displaying the created change event identifier and an event status corresponding to the created change event identifier on the sky environment control interface, the event status comprising an unchanged state, a changing state, and a pause changing state.

12. The method according to claim 1, wherein the sky environment control interface comprises a sky environment editing option; and the method further comprises:
displaying, in response to a trigger operation on the sky environment editing option, a sky environment editing sub-interface on the sky environment control interface;
obtaining a second environment parameter based on an editing operation in the sky environment editing sub-interface; and
changing the current sky environment in the virtual scene to a sky environment indicated by the second environment parameter.

13. The method according to claim 12, wherein the sky environment editing sub-interface comprises a preset option and a custom option; and the obtaining a second environment parameter based on an editing operation in the sky environment editing sub-interface comprises:
obtaining a preset environment parameter in response to a trigger operation on the preset option; or
obtaining, in response to a trigger operation on the custom option, an environment parameter determined based on a user operation.

14. The method according to claim 12, wherein the obtaining a second environment parameter based on an editing operation in the sky environment editing sub-interface comprises at least one of the following:
obtaining a second sky background parameter based on a sky background editing operation in the sky environment editing sub-interface; or
obtaining a second illumination parameter based on an illumination editing operation in the sky environment editing sub-interface;
the second environment parameter comprising at least one of the second sky background parameter and the second illumination parameter.

15. A computer device comprising a processor and a memory, the memory having at least one computer program stored therein, and the at least one computer program, when being loaded and executed by the processor, causing the computer device to implement a sky environment control method including:
displaying a sky environment control interface in a user generated content UGC editor;
obtaining, based on a sky environment change operation in the sky environment control interface, a change signal and a first environment parameter corresponding to the change signal; and
changing, in response to the change signal triggered in the virtual scene, a current sky environment in the virtual scene to a sky environment indicated by the first environment parameter.

16. The computer device according to claim 15, wherein the sky environment control interface comprises a sky environment change option; and the obtaining, based on a sky environment change operation in the sky environment control interface, a change signal and a first environment parameter corresponding to the change signal comprises:
displaying, in response to a trigger operation on the sky environment change option, a change event editing sub-interface on the sky environment control interface; and
obtaining the change signal and the first environment parameter based on an editing operation in the change event editing sub-interface.

17. The computer device according to claim 15, wherein the obtaining, based on a sky environment change operation in the sky environment control interface, a change signal and a first environment parameter corresponding to the change signal comprises:
obtaining the change signal, the first environment parameter, and transition duration based on the sky environment change operation; and
changing, in response to the change signal triggered in the virtual scene, in a manner of transitional change and within the transition duration, the current sky environment in the virtual scene to the sky environment indicated by the first environment parameter.

18. The computer device according to claim 15, wherein the obtaining, based on a sky environment change operation in the sky environment control interface, a change signal and a first environment parameter corresponding to the change signal comprises:
obtaining the change signal, the first environment parameter, and a pause changing signal based on the sky environment change operation; and
in the process of changing the sky environment in the virtual scene to the sky environment indicated by the first environment parameter, stopping, in response to the pause changing signal triggered in the virtual scene, changing the current sky environment in the virtual scene to the sky environment indicated by the first environment parameter.

19. The computer device according to claim 15, wherein the obtaining, based on a sky environment change operation in the sky environment control interface, a change signal and a first environment parameter corresponding to the change signal comprises:
obtaining the change signal, the first environment parameter, and an end signal based on the sky environment change operation; and
triggering the end signal in the virtual scene when changing to the sky environment indicated by the first environment parameter, the end signal being configured for triggering to start a particular event in the virtual scene.

20. A computer-readable storage medium having at least one computer program stored therein, and the at least one computer program, when being loaded and executed by a processor of a computer device, causing the computer device to implement a sky environment control method including:
displaying a sky environment control interface in a user generated content UGC editor;
obtaining, based on a sky environment change operation in the sky environment control interface, a change signal and a first environment parameter corresponding to the change signal; and
changing, in response to the change signal triggered in the virtual scene, a current sky environment in the virtual scene to a sky environment indicated by the first environment parameter.
